(19) United States
(12) Patent Application Publication
(10) Pub. No.: US 2007/0050944 A1
(43) Pub. Date: Mar. 8, 2007

(54) Free positioning hinge

(76) Inventor: Chin-Te Chiu, Tu-Cheng City (TW)

Correspondence Address: LIN & ASSOCIATES INTELLECTUAL PROPERTY, P.O. BOX 2339, SARATOGA, CA, 95070-0339, US

(21) Appl. No.: 11/221,150

(22) Filed: Sep. 7, 2005

(51) Int. Cl. E05D 11/08

(52) U.S. Cl. 16/342

(57) ABSTRACT

A free positioning hinge for connecting a stator element and a rotary element includes a sleeve, a rotary shaft, and a friction element. The sleeve has a coupling portion for coupling with the stator element and a mating portion opposite to the coupling portion having an axial hole defined therein. The rotary shaft has a connecting portion for connecting with the rotary element and an engaging portion opposite to the connecting portion for pivotally installed in the axial hole. The engaging portion includes a pivot and at least two retainers. The friction element includes a plurality of annular pads. The annular pads are disposed on the pivot and located between the retainers. The engaging portion of the rotary shaft together with the annular pads disposed thereon is inserted into the axial hole of the sleeve.

### BACKGROUND OF THE INVENTION

1. Field of the Invention

The present invention relates to a hinge, and more particularly, to a free positioning hinge.

2. The Related Art

Now, free positioning hinges are widely used in assembling the machine body of electronic devices, such as notebook computers, personal digital assistants, etc., having two portions which are pivotally connected through a hinge. In these devices, for example, as a display is opened to a position, it can be positioned in that position so as not to fall down due to the gravitational force. In this hinge, the friction between a rotary unit and a stator unit is utilized to resist the twisting force of the gravitational force. If the friction is too large, not only a large force is necessary to open the device, but also a large wearing or a further destroying occurs when the rotary unit rotates with respect to the stator unit. If the friction is too small, it is very possible that one portion slides unrestrainedly with respect to the other portion. Therefore, the frictional force between the rotary unit and the stator unit becomes the key point in designing the free positioning hinge.

In prior art, a type of free positioning hinge is formed through a sleeve having an axial hole and a rotary shaft having an engaging portion pivotally connected in the axial hole of the sleeve. In this type of free positioning hinge, a high precision of the components must be provided, so as to generate a proper friction between the sleeve and the rotary shaft. However, it is difficult to perform the high precision of the components in manufacturing, therefore, a larger cost is needed for manufacturing this type of free positioning hinge.

Latterly, as an improvement, a friction element is provided, which is assembled between the outer sleeve and the rotary shaft, for controlling the friction force. However, we know the friction element is commonly formed as flexible sleeve and conventionally inserted and fixed in the outer sleeve with no rotation with respect to the outer sleeve. Therefore, it is necessary to provide additional positioning mechanisms for fixing the friction element in the outer sleeve, thereby a high cost becoming a disadvantage in producing the positioning hinge. Furthermore, because of the friction element being formed from elastic material, the positioning mechanisms disposed on the friction element is easily destroyed when the rotary shaft acts a lager friction force on the friction element to urge the friction element to tend to rotate with respect to the sleeve. In this situation, the lifetime of the hinge device is reduced.

Therefore, a type of free positioning hinge, which not only has a simple and reliable structure, but also can provide a proper friction, is strongly desired.

### SUMMARY OF THE INVENTION

Accordingly, an object of the present invention is to provide a free positioning hinge in which a proper friction force can be generated for free positioning.

Another object of the present invention is to provide a free positioning hinge, which has a simple and reliable structure.

To achieve above objects, the present invention provides a free positioning hinge for connecting a stator element and a rotary element, which comprises a sleeve, a rotary shaft, and a friction element. The sleeve has a coupling portion for coupling with the stator element and a mating portion opposite to the coupling portion having an axial hole defined therein. The rotary shaft has a connecting portion for connecting with the rotary element and an engaging portion opposite to the connecting portion for pivotally installed in the axial hole. The engaging portion includes a pivot and at least two retainers. The friction element includes a plurality of annular pads. The annular pads are disposed on the pivot and located between the retainers. The engaging portion of the rotary shaft together with the annular pads disposed thereon is inserted into the axial hole of the sleeve.

It can be seen from the mentioned-above that, the friction element is formed with no special positioning mechanisms. Thereby the free positioning hinge of present invention has a simple structure. Furthermore, the friction element assembled between the rotary shaft and the sleeve are formed as annular pads, therefore, a proper friction force can be provided as the rotary shaft rotates with respect to the sleeve, and the likelihood of destroying the friction element is reduced.

### BRIEF DESCRIPTION OF THE DRAWINGS

The present invention will be apparent to those skilled in the art by reading the following description of an embodiment thereof, with reference to the attached drawings, in which:

FIG. 1 is an exploded view of a free positioning hinge of a first embodiment according to the present invention;

FIG. 2 is a cross sectional view of the free positioning hinge shown in FIG. 1 after it is assembled;

FIG. 3 is an exploded view of a free positioning hinge of a second embodiment according to the present invention;

FIG. 4 is a cross sectional view of the free positioning hinge shown in FIG. 3 after it is assembled; and

FIG. 5 is a partially enlarged view of the encircled portion labeled V of FIG. 2.

### DETAILED DESCRIPTION OF THE PREFERRED EMBODIMENT

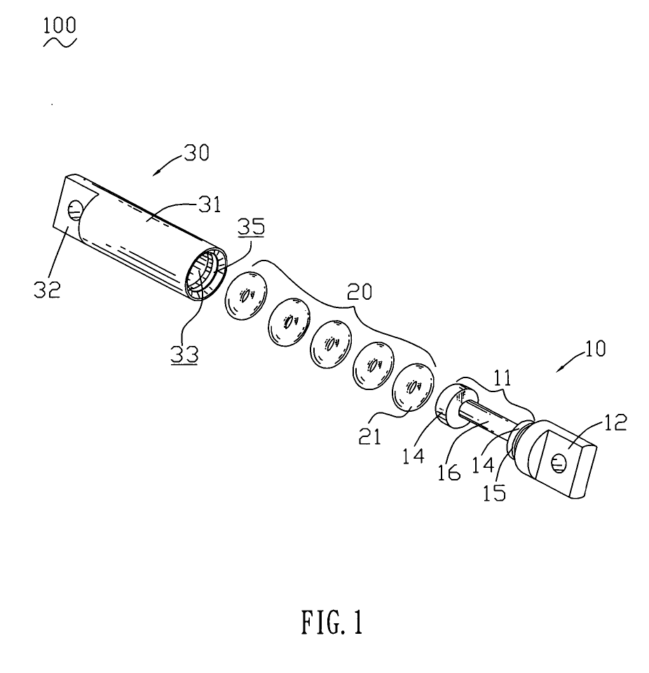

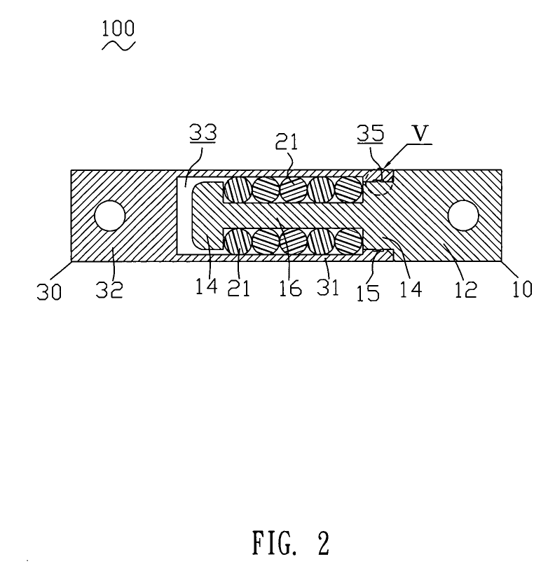

With reference to FIG. 1 and FIG. 2, a free positioning hinge 100 according to the present invention is illustrated. The free positioning hinge 100 includes a sleeve 30, a rotary shaft 10 pivotally engaged with the sleeve 30, and a friction element 20 assembled between the sleeve 30 and the rotary shaft 10.

The sleeve 30 has a coupling portion 32 for coupling with a stator element such as a mainframe in a notebook computer and a mating portion 31 opposite to the coupling portion 32 for mating with the rotary shaft 10. The mating portion 31 has an axial hole 33 axially defined therein. An annular recess 35 is further defined in an inner surface of the hole 33.

The rotary shaft 10 for engaging with the sleeve 30 has a connecting portion 12 for connecting with a rotary element such as a screen in the notebook computer and an engaging portion 11 opposite to the connecting portion 12 for engaging with the mating portion 31 of the sleeve 30. The engaging portion 11 is adapted to be pivotally installed in the axial hole 33 of the sleeve 30. The engaging portion 11 includes a pivot 16 and two retainers 14 disposed at two opposite ends of the pivot 16. An annular projection 15 is integrally formed around one retainer 14 for engaging with the recess 35 defined in the axial hole 33.

The friction element 20 includes a plurality of annular pads 21, which are formed from elastic materials, such as rubber or the like. Each annular pad 21 has an internal diameter that is slight smaller than a diameter of the pivot 16 and an external diameter that is slight larger than a diameter of the axial hole 33.

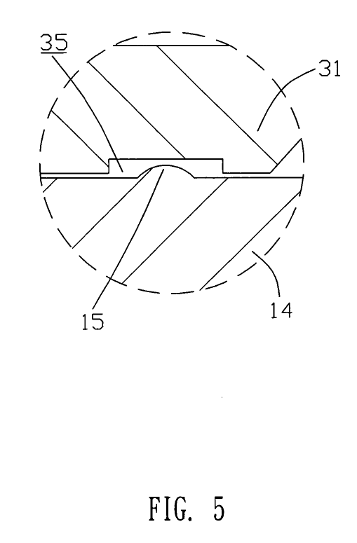

Please refer to FIG. 2 and FIG. 5. As assembling, firstly, with the help of the elasticity, the annular pads 21 can be disposed on the pivot 16 and located between the two retainers 14. Then the engaging portion 11 of the rotary shaft 10 together with the pads 21 disposed thereon is inserted in the axial hole 33 of the mating portion 31 of the sleeve 30 with the annular projection 15 engaging with the annular recess 35.

As described above, each annular pad 21 has an internal diameter that is slight smaller than the diameter of the pivot 16 and an external diameter that is slight larger than the diameter of the axial hole 33. Therefore, after the free positioning hinge 100 is completely assembled, the annular pads 21 are compressed between the sleeve 30 and the rotary shaft 10. Consequently, a friction force is generated between the sleeve 30 and the pads 21, and another friction force is generated between the rotary shaft 10 and the pads 21. So, when the friction force between the rotary shaft 10 and the pads 21 is larger than the friction force between the sleeve 30 and the pads 21, the pads 21 rotate together with the rotary shaft 10. Oppositely, when the friction force between the sleeve 30 and the pads 21 is larger than the friction force between the rotary shaft 10 and the pads 21, the rotary shaft 10 rotates with respect to the pads 21 and the sleeve 30. Therefore, in one aspect, a proper friction force is provided as the rotary shaft 10 rotating with respect to the sleeve 30. In another aspect, it is more difficult to destroy the friction element 20 as rotating, thereby prolonging the lifetime of the free positioning hinge 100.

As mentioned above, one advantage of present invention is the free positioning hinge 100 has a simple and reliable structure. Another advantage of present invention is that, by providing the annular pads 21 between the sleeve 30 and the rotary shaft 10, the free positioning hinge 100 can provide a proper friction force for free positioning.

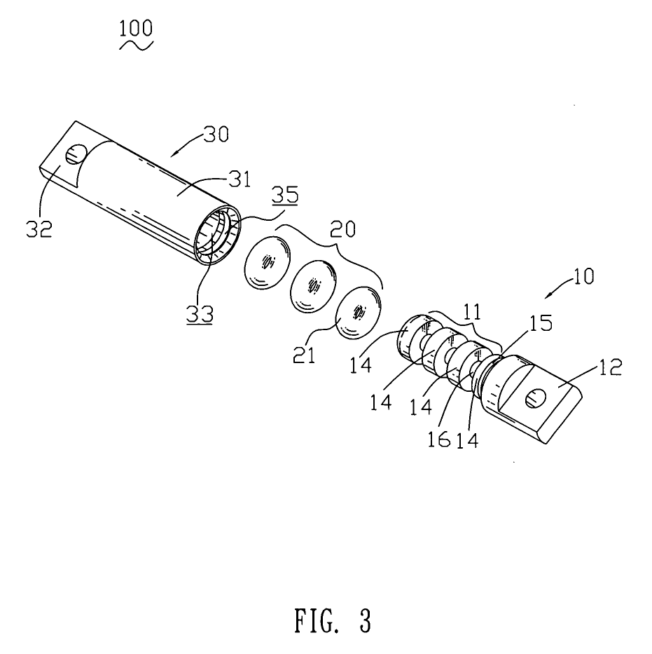

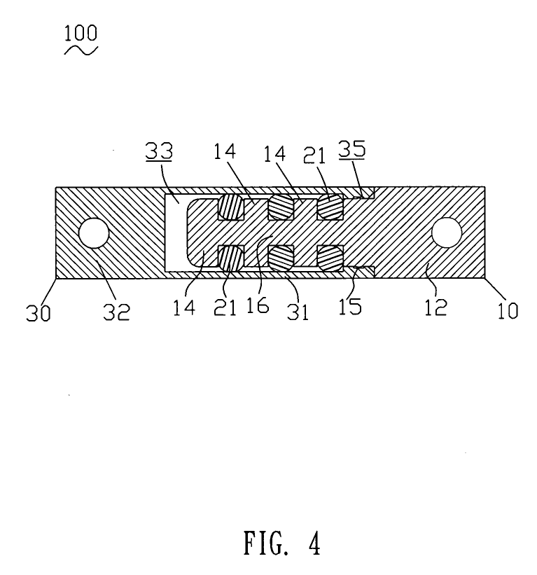

Please refer to FIG. 3 and FIG. 4. A second embodiment according to present invention is illustrated. After the first embodiment is described above, this embodiment can be understood very easily. Comparing to the first embodiment mentioned above, the difference is the numbers of the retainers 14 and the pads 21. Therefore, the similar free positioning function of the free positioning hinge 100 can be performed in this embodiment as well.

Although preferred embodiments of the present invention have been described in detail hereinabove, it should be clearly understood that many variations and/or modifications of the basic inventive concepts herein taught which may appear to those skilled in the present art will fall within the spirit and scope of the present invention, as defined in the appended claims.

What is claimed is:

1. A free positioning hinge for connecting a stator element and a rotary element, comprising:
a sleeve having a coupling portion for coupling with the stator element and a mating portion opposite to the coupling portion having an axial hole defined therein;
a rotary shaft having a connecting portion for connecting with the rotary element and an engaging portion opposite to the connecting portion for pivotally installed in said axial hole, the engaging portion including a pivot and at least two retainers; and
a friction element including a plurality of annular pads;
wherein the annular pads are disposed on the pivot and located between the retainers, the engaging portion of the rotary shaft together with the annular pads disposed thereon is inserted into the axial hole of the sleeve.

2. The free positioning hinge as claimed in claim 1, wherein said sleeve further has an annular recess defined in an inner surface of the axial hole, and said rotary shaft further has an annular projection formed around one of the retainers for engaging with the annular recess.

3. The free positioning hinge as claimed in claim 1, wherein the annular pads are formed from rubber.

4. The free positioning hinge as claimed in claim 1, wherein each of the annular pads has an internal diameter that is smaller than a diameter of the pivot and an external diameter that is larger than a diameter of the axial hole.
